(19) United States
(12) Patent Application Publication
(10) Pub. No.: US 2017/0211758 A1
(43) Pub. Date: Jul. 27, 2017

(54) LIGHT SOURCE, LUMINAIRE, AND METHOD OF MANUFACTURING LIGHT SOURCE

(71) Applicant: PANASONIC INTELLECTUAL PROPERTY MANAGEMENT CO., LTD., Osaka (JP)

(72) Inventors: Ikko KUZUHARA, Osaka (JP); Kenichiro TANAKA, Osaka (JP)

(73) Assignee: PANASONIC INTELLECTUAL PROPERTY MANAGEMENT CO., LTD., Osaka (JP)

(21) Appl. No.: 15/412,538

(22) Filed: Jan. 23, 2017

(30) Foreign Application Priority Data
Jan. 26, 2016 (JP) 2016-012805

(51) Int. Cl. F21K 9/68; F21V 7/04; F21V 7/00

(52) U.S. Cl. CPC F21K 9/68; F21V 7/0025; F21V 7/041; F21Y 2115/10

(57) ABSTRACT

A light source and corresponding method of manufacturing are provided. The light source includes a base. A first light-emitting element is disposed on the base and emits first emission light having a first spectrum. A second light-emitting element is disposed on the base adjacent to the first light-emitting element. The second light-emitting element emits second emission light having a second spectrum different from the first spectrum. A reflector is disposed between the first light-emitting element and the second light-emitting element. The reflector reflects, among components of the first emission light, a component of the first emission light that travels toward the second light-emitting element.

### CROSS REFERENCE TO RELATED APPLICATION

This application claims the benefit of priority of Japanese Patent Application Number 2016-012805 filed on Jan. 26, 2016, the entire content of which is hereby incorporated by reference.

### BACKGROUND

1. Technical Field

The present disclosure relates to a light source including a plurality of light-emitting elements having different spectra, a luminaire including the light source, and a method of manufacturing the light source.

2. Description of the Related Art

A light source including a plurality of light-emitting elements having different emission spectra is conventionally known (for example, Japanese Unexamined Patent Application Publication No. 2015-18612).

In the light source disclosed by Japanese Unexamined Patent Application Publication No. 2015-18612, a plurality of light-emitting elements having different emission spectra are used, thereby trying to achieve a light source capable of emitting light of an intended color temperature.

### SUMMARY

However, with the light source disclosed by Japanese Unexamined Patent Application Publication No. 2015-18612, the plurality of light-emitting elements having different emission spectra are disposed in proximity to each other. In this manner, light emitted from each of the light-emitting elements is mixed, in an attempt to uniform the emission color of light emitted from the light source. For this reason, there are instances where a portion of light emitted from a light-emitting element enters another light-emitting element disposed in proximity to the light-emitting element. In this case, light emission efficiency might be decreased due to absorption of the light which entered the other light-emitting element, or interference of the light which entered the other light-emitting element and emission light emitted from the other light-emitting element might occur, for example. Such a decrease in the light emission efficiency of a light source leads to an increase in power necessary for obtaining emission light of an intended intensity from the light source. This causes an increase in the amount of heat generated in the light-emitting elements in the light source, and thus product life of the light-emitting elements is reduced. In addition, there are instances where emission light having a spectrum assumed in design and an S/P ratio (ratio of scotopic vision luminance to photopic vision luminance) cannot be obtained by an actual light source due to a portion of light emitted from a light-emitting element entering another light-emitting element disposed in proximity to the light-emitting element.

In view of the above, an object of the present disclosure is to provide a light source including a plurality of light-emitting elements having different spectra and capable of suppressing light emitted from a light-emitting element entering another light-emitting element, a luminaire including the light source, and a method of manufacturing the light source.

In order to achieve the above-described object, a light source according to an aspect of the present disclosure includes: a base; a first light-emitting element which is disposed on the base and emits first emission light having a first spectrum; a second light-emitting element which is disposed on the base adjacent to the first light-emitting element, and emits second emission light having a second spectrum different from the first spectrum; and a reflector which is disposed between the first light-emitting element and the second light-emitting element, and reflects, among components of the first emission light, a component that travels toward the second light-emitting element.

In addition, in order to achieve the above-described object, a luminaire according to an aspect of the present disclosure includes the above-described light source.

In addition, in order to achieve the above-described object, a method of manufacturing the light source according to an aspect of the present disclosure is a method of manufacturing a light source including: a base; a first light-emitting element which emits first emission light having a first spectrum; and a second light-emitting element which emits second emission light having a second spectrum different from the first spectrum. The method includes: disposing the first light-emitting element on the base; disposing the second light-emitting element on the base adjacent to the first light-emitting element; and disposing a reflector between the first light-emitting element and the second light-emitting element, the reflector reflecting, among components of the first emission light, a component that travels toward the second light-emitting element.

According to an aspect of the present disclosure, it is possible to provide a light source including a plurality of light-emitting elements having different spectra and capable of suppressing light emitted from a light-emitting element entering another light-emitting element, a luminaire including the light source, and a method of manufacturing the light source.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a top view illustrating an external view of a light source according to Embodiment 1;

FIG. 2 is a cross-sectional diagram illustrating a configuration of the light source according to Embodiment 1;

FIG. 3A is a cross-sectional diagram illustrating a first process and a second process of a method of manufacturing the light source according to Embodiment 1;

FIG. 3B is a cross-sectional diagram illustrating a third process of a method of manufacturing the light source according to Embodiment 1;

FIG. 4 is a cross-sectional diagram illustrating a configuration of a light source according to Embodiment 2;

FIG. 5 is a cross-sectional diagram illustrating a configuration of a light source according to Embodiment 3;

FIG. 6A is a cross-sectional diagram illustrating a first process and a second process of a method of manufacturing the light source according to Embodiment 3;

FIG. 6B is a cross-sectional diagram illustrating a process of disposing transparent resin on a light-transmissive sheet in the third process of the method of manufacturing the light source according to Embodiment 3;

FIG. 6C is a cross-sectional diagram illustrating a process of causing a first light-emitting element and a second light-emitting element to be in contact with the transparent resin in the third process of the method of manufacturing the light source according to Embodiment 3;

FIG. 6D is a cross-sectional diagram illustrating a process of curing the transparent resin in the third process of the method of manufacturing the light source according to Embodiment 3;

FIG. 7 is a cross-sectional diagram illustrating a configuration of a light source according to Embodiment 4;

FIG. 8A is a cross-sectional diagram illustrating a first process and a second process of a method of manufacturing the light source according to Embodiment 4;

FIG. 8B is a cross-sectional diagram illustrating a process of disposing transparent resin on a first light-emitting element and a second light-emitting element in a third process of the method of manufacturing the light source according to Embodiment 4;

FIG. 8C is a cross-sectional diagram illustrating a process of causing a light-transmissive sheet to be in contact with the transparent resin in the third process of the method of manufacturing the light source according to Embodiment 4;

FIG. 8D is a cross-sectional diagram illustrating a process of curing the transparent resin in the third process of the method of manufacturing the light source according to Embodiment 4;

FIG. 9 is a cross-sectional diagram illustrating a configuration of a light source according to Embodiment 5; and

FIG. 10 is an external view of a luminaire according to Embodiment 6.

### DETAILED DESCRIPTION OF THE EMBODIMENTS

Embodiments according to the present disclosure will be described below with reference to the drawings. It should be noted that each of the embodiments described below shows a specific example of the present disclosure. Thus, the numerical values, shapes, materials, structural components, the disposition and connection of the structural components, and others described in the following embodiments are mere examples, and do not intend to limit the present disclosure. Therefore, among the structural components in the following embodiments, structural components not recited in any one of the independent claims which represent the most generic concepts of the present disclosure are described as arbitrary structural components.

In addition, each of the diagrams is a schematic diagram and thus is not necessarily strictly illustrated. In each of the diagrams, substantially the same structural components are assigned with the same reference signs, and redundant descriptions will be omitted or simplified.

### Embodiment 1

[1-1. Configuration]

First, a configuration of a light source according to Embodiment 1 shall be described with reference to the drawings.

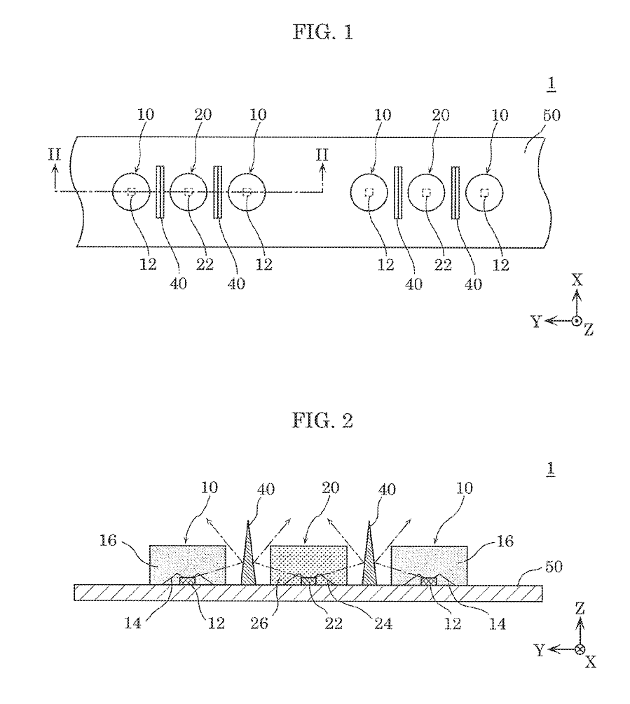

FIG. 1 is a top view illustrating an external view of light source 1 according to the present embodiment.

FIG. 2 is a cross-sectional diagram illustrating a configuration of light source 1 according to the present embodiment. FIG. 2 shows a cross-section surface taken along II-II of FIG. 1.

Light source 1 is, for example, a light-emitting module for use in a luminaire or the like. As illustrated in FIG. 1 and FIG. 2, light source 1 includes base 50, first light-emitting element 10, second light-emitting element 20, and reflector 40. A spectrum and a color temperature of light emitted from light source 1 are not specifically limited. According to the present embodiment, light source 1 emits light having a color temperature ranging from approximately 3000 K to 4000 K.

It should be noted that, in FIG. 1 and FIG. 2, the direction of axis Z is a direction perpendicular to a surface of base 50, on which first light-emitting element 10 and second light-emitting element 20 are disposed, and the direction of axis X and the direction of axis Y are perpendicular to the direction of axis Z and orthogonal to each other. According to the present embodiment, the direction of axis Y is the direction in which first light-emitting element 10 and second light-emitting element 20 are aligned.

Base 50 is a component on which first light-emitting element 10 and second light-emitting element 20 are mounted. The shape and the material of base 50 are not specifically limited. According to the present embodiment, base 50 is a mounting board which has a flat-plate shape. Board 50 is, for example, a ceramic board, a resin board, a metal base board, etc. On base 50, at least a pair of electrode terminals for externally receiving DC power for causing first light-emitting element 10 and second light-emitting element 20 to emit light, and a metal line of a predetermined pattern for supplying the DC power to first light-emitting element 10 and second light-emitting element 20 are formed.

First light-emitting element 10 is disposed on base 50 and emits first emission light having a first spectrum. According to the present embodiment, as illustrated in FIG. 2, first light-emitting element 10 includes first light-emitting diode chip 12 mounted on base 50, and first sealing component 16 that covers first light-emitting diode chip 12. In other words, first light-emitting element 10 is a light-emitting element of a chip on board (COB) type. First light-emitting diode chip 12 is, for example, a light-emitting diode (LED) which emits blue light, and is supplied with DC power via bonding wire 14 according to the present embodiment.

First sealing component 16 may include a first fluorescence component which converts a wavelength of light emitted from first light-emitting diode chip 12. For example, when first light-emitting element 10 emits light including red light, a blue light emitting diode chip is used as first light-emitting diode chip 12, and first sealing component 16 includes the first fluorescence component containing a red phosphor. It should be noted that the combination of first light-emitting diode chip 12 and first sealing component 16 is not limited to the-above described combination. For example, a red light-emitting diode chip may be used as first light-emitting diode chip 12, and a transparent resin which does not contain a phosphor may be used as first sealing component 16.

Second light-emitting element 20 is disposed adjacently to first light-emitting element 10 on base 50, and emits second emission light having a second spectrum which is different from the first spectrum. According to the present embodiment, as illustrated in FIG. 2, second light-emitting element 20 includes second light-emitting diode chip 22 mounted on base 50, and second sealing component 26 that covers second light-emitting diode chip 22. In other words, second light-emitting element 20 is a light-emitting element of the COB type as with first light-emitting element 10. Second light-emitting diode chip 22 is, for example, a light-emitting diode which emits blue light, and is supplied with DC power via bonding wire 24 according to the present embodiment.

Second sealing component 26 may include a second fluorescence component which converts a wavelength of light emitted from second light-emitting diode chip 22. For example, when second light-emitting element 20 emits light including blue-green light, a blue light-emitting diode chip is used as second light-emitting diode chip 22, and second sealing component 26 includes the second fluorescence component containing a green phosphor. It should be noted that the combination of second light-emitting diode chip 22 and second sealing component 26 is not limited to the-above described combination. For example, an ultraviolet light emitting diode chip may be used as second light-emitting diode chip 22, and second sealing component 26 may include a second fluorescence component containing a blue phosphor and a green phosphor.

As described above, first light-emitting element 10 emits first emission light including red light and second light-emitting element 20 emits second emission light including blue-green light, thereby making it possible to emit light having a color temperature approximately ranging from 3000 K to 4000 K from light source 1.

Sizes of first light-emitting element 10 and second light-emitting element 20 are not specifically limited. The size of each of first light-emitting element 10 and second light-emitting element 20 in the direction parallel to a front surface of base 50 is approximately 0.6 mm, for example. In addition, a gap between first light-emitting element 10 and second light-emitting element 20 is not specifically limited. According to the present embodiment, the gap approximately ranges from 0.2 mm to 0.5 mm. As described above, when the gap between first light-emitting element 10 and second light-emitting element 20 is, for example, equal to or smaller than approximately five times as large as a thickness (i.e., a height from a mounting surface of base 50) of first light-emitting element 10 or second light-emitting element 20, effects of a component that travels toward second light-emitting element 20 among components of the first emission light; and a component that travels toward first light-emitting element 10 among components of the second emission light become prominent. For example, when the thickness of first light-emitting element 10 or second light-emitting element 20 is 0.2 mm, the effects become prominent in the case where the gap between first light-emitting element 10 and second light-emitting element 20 is approximately equal to or smaller than 1.0 mm.

Reflector 40 is a component disposed between first light-emitting element 10 and second light-emitting element 20, and reflects, among components of the first emission light, a component that travels toward second light-emitting element 20. According to the present embodiment, reflector 40 also reflects, among components of the second emission light, a component that travels toward first light-emitting element 10. In addition, according to the present embodiment, reflector 40 is white in color and has a dam-like shape, and is erected on base 50. The shape of reflector 40 is not specifically limited as long as the shape allows reflecting in an intended direction: a component that travels toward second light-emitting element 20 among components of the first emission light; and a component that travels toward first light-emitting element 10 among components of the second emission light. In the example illustrated in FIG. 2, reflector 40 has a shape of a substantially triangular pole. In this example, as illustrated by dashed-dotted directional lines in FIG. 2, reflector 40 reflects, among components of the first emission light, a component that travels toward second light-emitting element 20, toward a main emission direction of first light-emitting element 10 (direction of axis Z). Furthermore, reflector 40 reflects, among components of the second emission light, a component that travels toward first light-emitting element 10, toward a main emission direction of second light-emitting element 20 (direction of axis Z). It should be noted that the main emission direction is an emission direction in which the intensity of emission light from each of the light-emitting elements is the maximum. According to the present embodiment, the main emission direction of each of the light-emitting elements is identical to an optical axis direction of each of the light-emitting elements. A material of reflector 40 is not specifically limited as long as the material is capable of reflecting the first emission light and the second emission light. As the material of reflector 40, for example, a white resin such as polybutylene terephthalate (PBT) and a white silicone resin may be used.

Reflector 40 is capable of reflecting, among components of the first emission light emitted from first light-emitting element 10, a component that travels toward second light-emitting element 20, and thus it is possible to reduce, among the components of the first emission light, components that enter second light-emitting element 20. Furthermore, reflector 40 is capable of reflecting, among components of the second emission light emitted from second light-emitting element 20, a component that travels toward first light-emitting element 10, and thus it is possible to reduce, among the components of the second emission light, components that enter first light-emitting element 10. In this manner, it is possible to reduce components that are absorbed by second light-emitting element 20 among the components of the first emission light, and components that are absorbed by first light-emitting element 10 among the components of the second emission light. Thus, it is possible to enhance the light emission efficiency of light source 1.

In addition, first light-emitting element 10 and second light-emitting element 20 of light source 1 according to the present embodiment are each a light-emitting element of the COB type. Accordingly, a light distribution angle of light emitted from each of the light-emitting elements is relatively broad. In other words, relatively a large number of components travel toward second light-emitting element 20 among the components of the first emission light, and relatively a large number of components travel toward first light-emitting element 10 among the components of the second emission light. Thus, the advantageous effect produced by reflector 40 is more prominent.

[1-2. A Manufacturing Method]

Next, a method of manufacturing light source 1 according to the present embodiment shall be described with reference to the drawings.

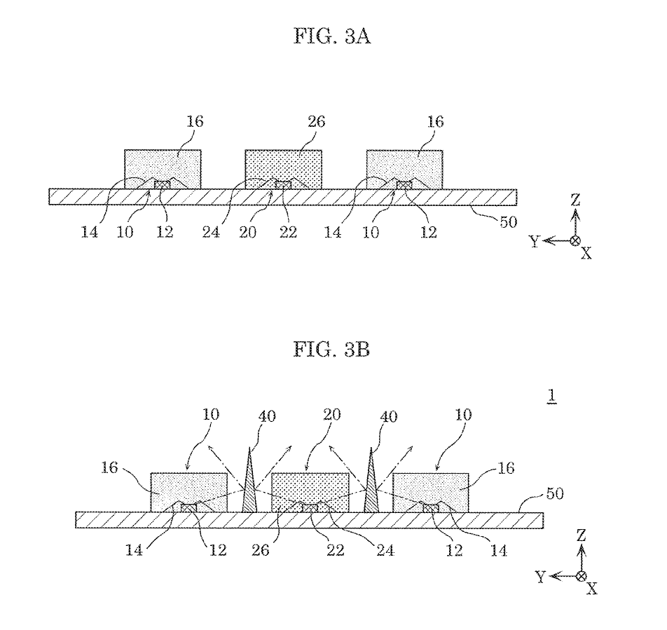

FIG. 3A is a cross-sectional diagram illustrating a first process and a second process of a method of manufacturing light source 1 according to the present embodiment. FIG. 3A shows a cross-section surface corresponding to the cross-section surface II-II illustrated in FIG. 1.

FIG. 3B is a cross-sectional diagram illustrating a third process of the method of manufacturing light source 1 according to the present embodiment. FIG. 3B shows a cross-section surface taken along II-II illustrated in FIG. 1.

First, as illustrated in FIG. 3A, the first process and the second process are performed. In the first process, first light-emitting element 10 is disposed on base 50. In the second process, second light-emitting element 20 is disposed adjacently to first light-emitting element 10 on base 50.

In the method of manufacturing light source 1 according to the present embodiment, the first process includes a process of mounting first light-emitting diode chip 12 on base 50, and a process of disposing first sealing component 16 which covers first light-emitting diode chip 12. In addition, the second process includes a process of mounting second light-emitting diode chip 22 on base 50, and a process of disposing second sealing component 26 which covers second light-emitting diode chip 22.

It should be noted that the order of the first process and the second process is not specifically limited. For example, the first process may be performed after the second process. Alternatively, the first process and the second process may be performed in parallel. In other words, first sealing component 16 and second sealing component 26 may be disposed after first light-emitting diode chip 12 and second light-emitting diode chip 22 are mounted on base 50.

Subsequent to the first process and the second process, the third process of disposing, between first light-emitting element 10 and second light-emitting element 20, reflector 40 which reflects, among components of first emission light, a component that travels toward second light-emitting element 20 is performed.

How to form reflector 40 is not specifically limited. For example, a white resin formed into a dam-like shape in advance may be fixed to base 50 using an adhesive member or the like, or a white resin disposed on base 50 may be processed to have a dam-like shape. In addition, reflector 40 may be disposed on base 50 before first light-emitting element 10 and second light-emitting element 20 are disposed on base 50, or may be disposed on base 50 after first light-emitting element 10 and second light-emitting element 20 are disposed on base 50.

It should be noted that, in the method of manufacturing light source 1 according to the present embodiment, the third process may be performed before the first process and the second process are performed.

With the manufacturing method including the first process, the second process, and the third process described above, it is possible to manufacture light source 1 according to the present embodiment.

[1-3. Conclusion]

As described above, light source 1 according to the present embodiment includes: base 50; first light-emitting element 10 which is disposed on base 50 and emits first emission light having a first spectrum; and second light-emitting element 20 which is disposed on base 50 adjacent to first light-emitting element 10, and emits second emission light having a second spectrum different from the first spectrum. Light source 1 further includes reflector 40 which is disposed between first light-emitting element 10 and second light-emitting element 20, and reflects, among components of the first emission light, a component that travels toward second light-emitting element 20.

In this manner, light source 1 according to the present embodiment is capable of reflecting, among components of the first emission light emitted from first light-emitting element 10, a component that travels toward second light-emitting element 20, and thus it is possible to reduce components that enter second light-emitting element 20 among the components of the first emission light. Accordingly, it is possible to reduce, among the components of the first emission light, components that are lost due to, for example, absorption by second light-emitting element 20. Thus, it is possible to enhance the light emission efficiency of light source 1.

In addition, in light source 1, reflector 40 may reflect, among components of the second emission light, a component that travels toward first light-emitting element 10.

In this manner, it is possible to reflect, among the components of the second emission light emitted from second light-emitting element 20, a component that travels toward first light-emitting element 10, and thus it is possible to reduce, among the components of the second emission light, components that enter first light-emitting element 10. Accordingly, it is possible to reduce, among the components of the second emission light, components that are lost due to, for example, absorption by first light-emitting element 10. Thus, it is possible to enhance the light emission efficiency of light source 1.

In addition, in light source 1, first light-emitting element 10 may include first light-emitting diode chip 12 disposed on base 50, and first sealing component 16 that covers first light-emitting diode chip 12. Second light-emitting element 20 may include second light-emitting diode chip 22 disposed on base 50 and second sealing component 26 that covers second light-emitting diode chip 22.

In this manner, when first light-emitting element 10 and second light-emitting element 20 are each a light-emitting element of a COB type, a light distribution angle of light emitted from each of the light-emitting elements is relatively broad. More specifically, relatively a large number of components travel toward second light-emitting element 20 among the components of the first emission light, and relatively a large number of components travel toward first light-emitting element 10 among the components of the second emission light. Thus, the advantageous effect produced by reflector 40 is more prominent.

In addition, in light source 1, reflector 40 may be white in color and have a dam-like shape, and be disposed in a standing manner on base 50.

In this manner, it is possible to reliably reflect: a component that travels toward second light-emitting element 20 among the components of the first emission light; and a component that travels toward first light-emitting element 10 among the components of the second emission light.

In addition, in light source 1, a distance between first light-emitting element 10 and second light-emitting element 20 may be at most equal to five times a thickness of one of first light-emitting element 10 and second light-emitting element 20. In addition, in light source 1, reflector 40 may have a shape of a triangular pole, and reflector 40 may reflect the component of the first emission light toward a main emission direction of first light-emitting element 10.

In addition, the method of manufacturing light source 1 according to the present embodiment is a method of manufacturing a light source including: base 50; first light-emitting element 10 which emits first emission light having a first spectrum; and second light-emitting element 20 which emits second emission light having a second spectrum different from the first spectrum. The method of manufacturing light source 1 includes the first process in which first light-emitting element 10 is disposed on base 50 and the second process in which second light-emitting element 20 is disposed on base 50 adjacent to first light-emitting element 10. The method of manufacturing light source 1 further includes the third process of disposing, between first light-emitting element 10 and second light-emitting element 20, reflector 40 which reflects, among components of the first emission light, a component that travels toward second light-emitting element 20.

In this manner, it is possible to manufacture light source 1 which reflects, among the components of the first emission light emitted from first light-emitting element 10, the component that travels toward second light-emitting element 20. Light source 1 manufactured through the above-described method of manufacturing is capable of reducing, among the components of the first emission light, components that enter second light-emitting element 20. Accordingly, it is possible to reduce, among the components of the first emission light, components that are lost due to, for example, absorption by second light-emitting element 20. Thus, it is possible to enhance the light emission efficiency of light source 1.

In addition, in the method of manufacturing light source 1, the first process may include a process of mounting first light-emitting diode chip 12 on base 50, and a process of covering first light-emitting diode chip 12 with first sealing component 16. The second process may include a process of mounting second light-emitting diode chip 22 on base 50, and a process of covering second light-emitting diode chip 22 with second sealing component 26.

In this manner, when first light-emitting element 10 and second light-emitting element 20 are each a light-emitting element of the COB type, a light distribution angle of light emitted from each of the light-emitting elements is relatively broad. More specifically, relatively a large number of components travel toward second light-emitting element 20 among the components of the first emission light, and relatively a large number of components travel toward first light-emitting element 10 among the components of the second emission light. Thus, the advantageous effect produced by reflector 40 is more prominent.

In addition, in the method of manufacturing light source 1, the third process may be performed after the first process and the second process are performed.

### Embodiment 2

The following describes a light source according to Embodiment 2. The light source according to the present embodiment is different in the configuration of the reflector from light source 1 according to Embodiment 1. The following describes the light source according to the present embodiment focusing on the difference from light source 1 according to Embodiment 1.

[2-1. Configuration]

A configuration of the light source according to the present embodiment shall be described with reference to the drawings.

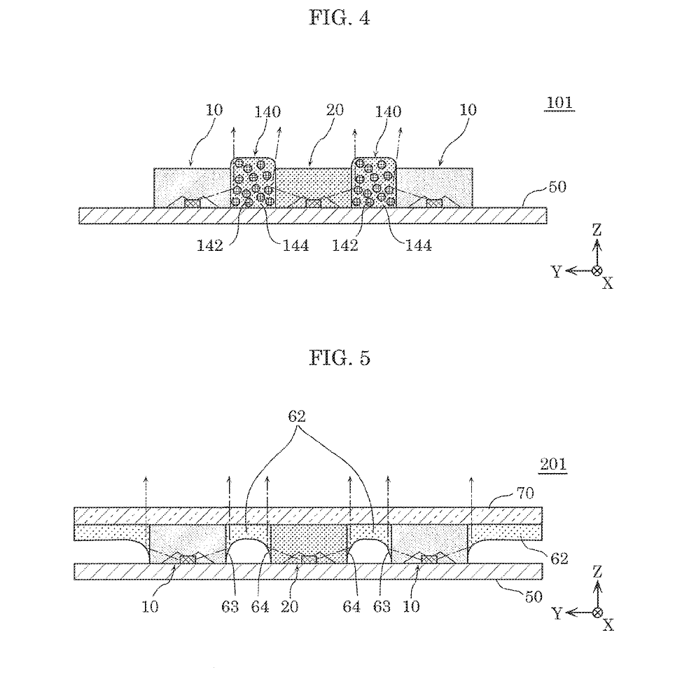

FIG. 4 is a cross-sectional diagram illustrating a configuration of light source 101 according to the present embodiment. FIG. 4 shows, as with FIG. 2, a cross-section surface of a plane passing through substantially the center of first light-emitting element 10 and second light-emitting element 20 of light source 101 and parallel to an YZ plane. Same or similar cross-section surfaces are shown also in the cross-sectional diagrams which will be referred to below.

As illustrated in FIG. 4, light source 101 according to the present embodiment, as with light source 1 according to Embodiment 1, includes: base 50; first light-emitting element 10; second light-emitting element 20; and reflector 140.

According to the present embodiment, reflector 140 is a diffuser. Reflector 140 is not specifically limited as long as reflector 140 is a component which diffuses light. According to the present embodiment, reflector 140 includes light-transmissive resin 144 and diffuser particle 142 contained in light-transmissive resin 144. With reflector 140 having the above-described configuration, it is possible to diffuse, among components of the first emission light, components that travel toward second light-emitting element 20, as illustrated by dashed-dotted directional lines in FIG. 4. For that reason, it is possible to suppress the components entering second light-emitting element 20. In the same manner as above, with reflector 140, it is possible to suppress the components that travel toward first light-emitting element 10, among components of the second emission light, entering first light-emitting element 10.

A material of diffuser particle 142 is not specifically limited as long as the material is capable of diffusing light. As diffuser particle 142, for example, silica can be employed.

The material of light-transmissive resin 144 is not specifically limited as long as the material is light transmissive. As light-transmissive resin 144, for example, a silicone resin can be employed.

[2-2. A Manufacturing Method]

Next, a method of manufacturing light source 101 according to the present embodiment shall be described.

The method of manufacturing light source 101 according to the present embodiment includes, as with Embodiment 1, the first process in which first light-emitting element 10 is disposed on base 50 and the second process in which second light-emitting element 20 is disposed adjacently to first light-emitting element 10 on base 50. The method of manufacturing light source 101 further includes the third process of disposing, between first light-emitting element 10 and second light-emitting element 20, reflector 140 which reflects, among components of the first emission light, a component that travels toward second light-emitting element 20.

Meanwhile, the method of manufacturing light source 101 according to the present embodiment is different in the third process from the method of manufacturing light source 1 according to Embodiment 1. How to dispose reflector 140 in the third process is not specifically limited. Reflector 140 is formed, for example, by applying, between first light-emitting element 10 and second light-emitting element 20, a light-transmissive resin in liquid form in which diffuser particles 142 are dispersedly contained, and curing the light-transmissive resin. In this manner, it is possible to easily form reflector 140 even when a gap between first light-emitting element 10 and second light-emitting element 20 is narrow, according to the present embodiment.

[2-3. Conclusion]

As described above, in light source 101 according to the present embodiment, reflector 140 is a diffuser.

With this configuration, it is possible to diffuse, among components of the first emission light, components that travel toward second light-emitting element 20. For that reason, it is possible to suppress the component entering second light-emitting element 20. In the same manner as above, with reflector 140, it is possible to suppress the components that travel toward first light-emitting element 10, among components of the second emission light, entering first light-emitting element 10.

In addition, in light source 101, reflector may include light-transmissive resin 144 and diffuser particle 142 contained in light-transmissive resin 144.

In this manner, it is possible to easily form reflector 140 even when a gap between first light-emitting element 10 and second light-emitting element 20 is narrow.

### Embodiment 3

The following describes a light source according to Embodiment 3. The light source according to the present embodiment is different in the configuration of the reflector from each of the light sources according to the above-described embodiments. The reflector according to the present embodiment has a configuration which is easy to be formed even when the gap between first light-emitting element 10 and second light-emitting element 20 is narrow. The following describes the light source according to the present embodiment focusing on the difference from each of the light sources according to the above-described embodiments.

[3-1. Configuration]

The following describes a configuration of the light source according to the present embodiment, with reference to the drawings.

FIG. 5 is a cross-sectional diagram illustrating a configuration of light source 201 according to the present embodiment.

As illustrated in FIG. 5, light source 201 according to the present embodiment includes, as with each of the light sources according to the above-described embodiments, base 50, first light-emitting element 10, second light-emitting element 20, and reflector 62. Light source 201 according to the present embodiment is disposed opposite to base 50, and further includes light-transmissive sheet 70 that covers first light-emitting element 10 and second light-emitting element 20. Reflector 62 is a transparent component disposed on light-transmissive sheet 70, and totally reflects, among components of the first emission light, a component that travels toward second light-emitting element 20. As illustrated by dashed-dotted directional lines in FIG. 5, the component is totally reflected off a surface of fillet section 63 of reflector 62. Fillet section 63 is formed in proximity to first light-emitting element 10. In the same manner as above, among components of the second emission light, a component that travels toward first light-emitting element 10 is totally reflected off a surface of fillet section 64 of reflector 62. Fillet section 64 is formed in proximity to second light-emitting element 20. Accordingly, with reflector 62, it is possible to reflect, at high reflectance, components that travel toward second light-emitting element 20 among the components of the first emission light, and components that travel toward first light-emitting element 10 among the components of the second emission light. Accordingly, with reflector 62, it is possible to further reduce components that enter second light-emitting element 20 among the components of the first emission light, and components that enter first light-emitting element 10 among the components of the second emission light.

The material of light-transmissive sheet 70 is not specifically limited as long as the material is light transmissive. As the material of light-transmissive sheet 70, for example, a transparent component such as polycarbonate (PC) and glass can be used.

The material of reflector 62 is not specifically limited as long as the material is transparent. As reflector 62, for example, a silicone resin can be employed.

[3-2. A Manufacturing Method]

Next, a method of manufacturing light source 201 according to the present embodiment shall be described with reference to the drawings.

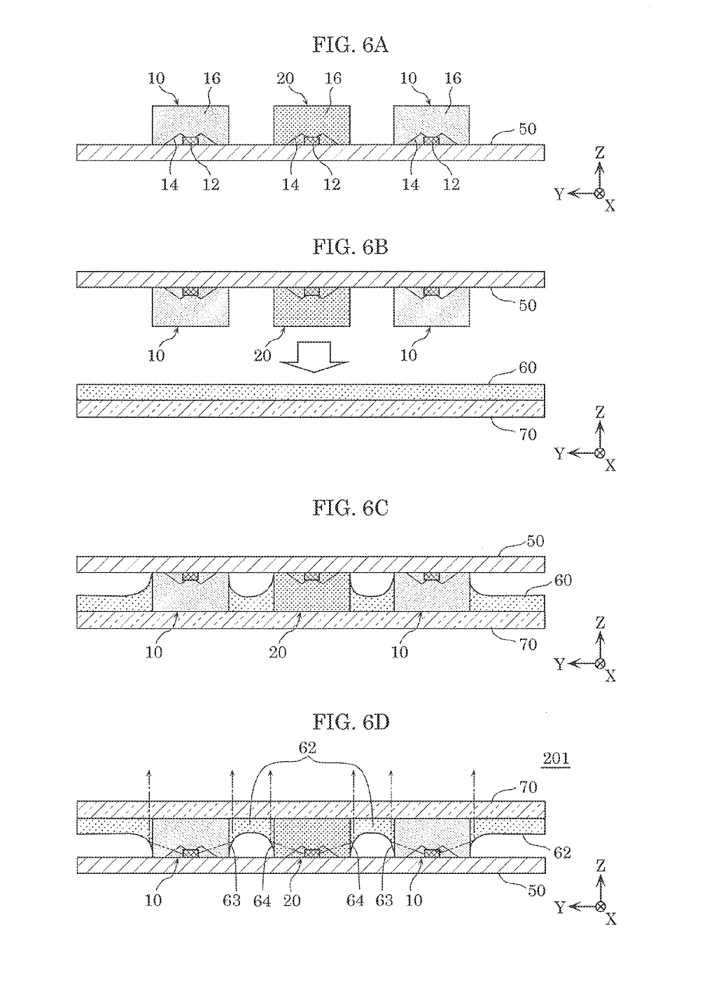

FIG. 6A is a cross-sectional diagram illustrating a first process and a second process of the method of manufacturing light source 201 according to the present embodiment.

FIG. 6B is a cross-sectional diagram illustrating a process of disposing transparent resin 60 on light-transmissive sheet 70 in the third process of the method of manufacturing light source 201 according to the present embodiment.

FIG. 6C is a cross-sectional diagram illustrating a process of causing first light-emitting element 10 and second light-emitting element 20 to be in contact with transparent resin 60 in the third process of the method of manufacturing light source 201 according to the present embodiment.

FIG. 6D is a cross-sectional diagram illustrating a process of curing transparent resin 60 in the third process of the method of manufacturing light source 201 according to the present embodiment.

First, in the method of manufacturing light source 201 according to the present embodiment, as illustrated in FIG. 6A, the first process and the second process are performed. In the first process, first light-emitting element 10 is disposed on base 50. In the second process, second light-emitting element 20 is disposed adjacently to first light-emitting element 10 on base 50. The first process and the second process are same as the first process and the second process of each of the above-described embodiments.

Subsequent to the first process and the second process, the third process of disposing, between first light-emitting element 10 and second light-emitting element 20, reflector 62 which reflects, among components of the first emission light, a component that travels toward second light-emitting element 20 is performed.

The third process includes a forming process of forming, as reflector 62, a transparent component on light-transmissive sheet 70 covering first light-emitting element 10 and second light-emitting element 20. The transparent component totally reflects the component that travels toward second light-emitting element 20 among the components of the first emission light. In this manner, disposing of reflector 62 on light-transmissive sheet 70 eliminates the necessity of providing base 50 with a reflector. Accordingly, the method of manufacturing light source 201 is especially effective in the case where the gap between first light-emitting element 10 and second light-emitting element 20 is narrow and thus it is difficult to dispose a reflector on base 50.

According to the present embodiment, as illustrated in FIG. 6B, the forming process includes: a process of disposing transparent resin 60 in liquid form on an upper side of light-transmissive sheet 70 in a vertical direction; and a process of causing first light-emitting element 10 and second light-emitting element 20 which are disposed on base 50 to be in contact with transparent resin 60. When first light-emitting element 10 and second light-emitting element 20 are caused to be in contact with transparent resin 60, there is a possibility that transparent resin 60 might flow down from light-transmissive sheet 70 if light-transmissive sheet 70 is turned over such that transparent resin 60 in liquid form is disposed on a lower side of light-transmissive sheet 70 in a vertical direction. For that reason, according to the present embodiment, first light-emitting element 10 and second light-emitting element 20 are disposed on the lower side of base 50 in a vertical direction, by turning over base 50 on which first light-emitting element 10 and second light-emitting element 20 are disposed. In this manner, it is possible to cause first light-emitting element 10 and second light-emitting element 20 to be in contact with transparent resin 60 in a state in which transparent resin 60 in liquid form is stably disposed on light-transmissive sheet 70. According to the present embodiment, first light-emitting element 10 and second light-emitting element 20 are caused to sink into transparent resin 60 as illustrated in FIG. 6C. In other words, first light-emitting element 10 and second light-emitting element 20 are pressed to light-transmissive sheet 70 to cause a portion of each of first light-emitting element 10 and second light-emitting element 20 on a side close to light-transmissive sheet 70 to be disposed inside transparent resin 60. In this manner, transparent resin 60 is attached to a portion of a side surface (a portion of a front surface in which a normal line intersects the direction of axis Z) of each of first light-emitting element 10 and second light-emitting element 20.

In addition, the forming process further includes a process of curing transparent resin 60 to be reflector 62, in a state in which first light-emitting element 10 and second light-emitting element 20 are in contact with transparent resin 60, as illustrated in FIG. 6D. As illustrated in FIG. 6D, reflector 62 includes fillet section 63 and fillet section 64 which are formed in proximity to a side surface of first light-emitting element 10 and a side surface of second light-emitting element 20, respectively, when transparent resin 60 is cured in the state in which first light-emitting element 10 and second light-emitting element 20 are in contact with transparent resin 60 in liquid form. Fillet section 63 and fillet section 64 are respectively formed as a result of transparent resin 60 being cured while shrinking, in a state in which an upper end portion of transparent resin 60 in a vertical direction (direction of axis Z) is attached to the side surface of each of first light-emitting element 10 and second light-emitting element 20. It is possible to totally reflect a component that travels toward second light-emitting element 20 among components of the first emission light, off fillet section 63 formed in proximity to the side surface of first light-emitting element 10. In the same manner as above, it is possible to totally reflect a component that travels toward first light-emitting element 10 among components of the second emission light, off fillet section 64 formed in proximity to the side surface of second light-emitting element 20.

With the manufacturing method including the first process, the second process, and the third process described above, it is possible to manufacture light source 201 according to the present embodiment.

[3-3. Conclusion]

As described above, light source 201 according to the present embodiment further includes light-transmissive sheet 70 that is disposed opposite to base 50 and covers first light-emitting element 10 and second light-emitting element 20. Reflector 62 of light source 201 includes a transparent component disposed on light-transmissive sheet 70, and reflects a component of the first emission light that travels toward second light-emitting element 20.

This configuration allows light source 201 according to the present embodiment to reflect, at high reflectance, among components of the first emission light emitted from first light-emitting element 10, a component that travels toward second light-emitting element 20, and thus it is possible to further reduce, among the components of the first emission light, components that enter second light-emitting element 20.

In addition, in the method of manufacturing light source 201, the third process includes the forming process of forming, as reflector 62, the transparent component on light-transmissive sheet 70 covering first light-emitting element 10 and second light-emitting element 20. The transparent component reflects the component of the first emission light that travels toward second light-emitting element 20.

In this manner, disposing of reflector 62 on light-transmissive sheet 70 eliminates the necessity of providing base 50 with a reflector. Accordingly, the method of manufacturing light source 201 is especially effective in the case where the gap between first light-emitting element 10 and second light-emitting element 20 is narrow and thus it is difficult to dispose a reflector on base 50.

In addition, in the method of manufacturing of light source 201 according to the present embodiment, the forming process may include: the process of disposing transparent resin 60 in liquid form on a side of light-transmissive sheet 70; and the process of causing first light-emitting element 10 and second light-emitting element 20 which are disposed on base 50 to be in contact with transparent resin 60. The forming process may further include the process of curing transparent resin 60 to form reflector 62, in the state in which first light-emitting element 10 and second light-emitting element 20 are in contact with transparent resin 60.

In this manner, it is possible to easily dispose reflector 62 even when the gap between first light-emitting element 10 and second light-emitting element 20 is narrow.

### Embodiment 4

The following describes a light source according to Embodiment 4. The light source according to the present embodiment includes a reflector formed of a transparent component which totally reflects a component that travels toward second light-emitting element 20 among components of the first emission light, as with light source 201 according to Embodiment 3. The present embodiment is different from Embodiment 3 mainly in the method of manufacturing the light source. The following describes the light source according to the present embodiment focusing on the difference from light source 201 according to Embodiment 3.

[4-1. Configuration]

The following describes a configuration of the light source according to the present embodiment, with reference to the drawings.

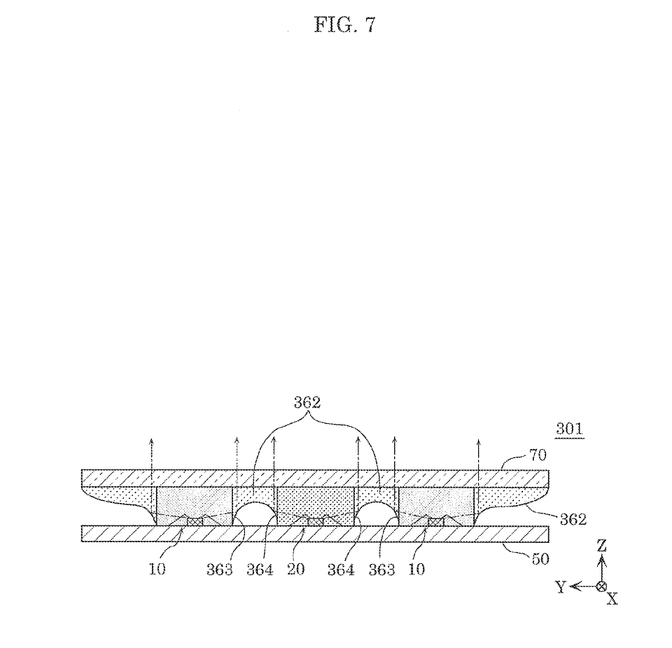

FIG. 7 is a cross-sectional diagram illustrating a configuration of light source 301 according to the present embodiment.

As illustrated in FIG. 7, light source 301 according to the present embodiment, as with light source 201 according to Embodiment 3, includes: base 50; first light-emitting element 10; second light-emitting element 20; reflector 362; and light-transmissive sheet 70. Reflector 362 is a transparent component disposed on light-transmissive sheet 70, and totally reflects, among the components of the first emission light, the component that travels toward second light-emitting element 20. As illustrated by dashed-dotted directional lines in FIG. 7, the component is totally reflected off a surface of fillet section 363 of reflector 362. Fillet section 363 is formed in proximity to first light-emitting element 10. In the same manner as above, among components of the second emission light, a component that travels toward first light-emitting element 10 is totally reflected off a surface of fillet section 364 of reflector 362. Fillet section 364 is formed in proximity to second light-emitting element 20. In this manner, with reflector 362, it is possible to reduce components that enter second light-emitting element 20 among the components of the first emission light, and components that enter first light-emitting element 10 among the components of the second emission light.

The material of reflector 362 is not specifically limited as long as the material is transparent. As reflector 362, for example, a silicone resin etc. can be employed.

[4-2. A Manufacturing Method]

Next, a method of manufacturing light source 301 according to the present embodiment shall be described with reference to the drawings.

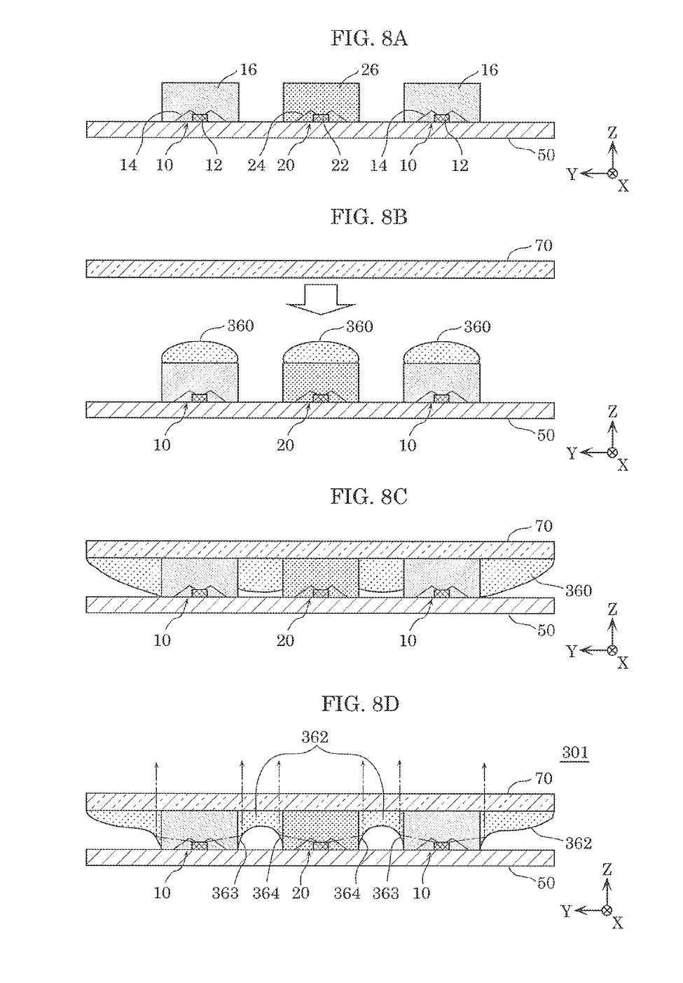

FIG. 8A is a cross-sectional diagram illustrating a first process and a second process of the method of manufacturing light source 301 according to the present embodiment.

FIG. 8B is a cross-sectional diagram illustrating a process of disposing transparent resin 360 on first light-emitting element 10 and second light-emitting element 20 in the third process of the method of manufacturing light source 301 according to the present embodiment.

FIG. 8C is a cross-sectional diagram illustrating a process of causing light-transmissive sheet 70 to be in contact with transparent resin 360 in the third process of the method of manufacturing light source 301 according to the present embodiment.

FIG. 8D is a cross-sectional diagram illustrating a process of curing transparent resin 60 in the third process of the method of manufacturing light source 301 according to the present embodiment.

First, in the method of manufacturing light source 301 according to the present embodiment, as illustrated in FIG. 8A, the first process and the second process are performed. In the first process, first light-emitting element 10 is disposed on base 50. In the second process, second light-emitting element 20 is disposed adjacently to first light-emitting element 10 on base 50. The first process and the second process are same as the first process and the second process of each of the above-described embodiments.

Subsequent to the first process and the second process, the third process of disposing, between first light-emitting element 10 and second light-emitting element 20, reflector 362 which reflects, among components of the first emission light, a component that travels toward second light-emitting element 20 is performed.

The third process includes a forming process of forming, as reflector 362, a transparent component on light-transmissive sheet 70 covering first light-emitting element 10 and second light-emitting element 20. The transparent component totally reflects the component that travels toward second light-emitting element 20 among the components of the first emission light.

According to the present embodiment, the forming process includes a process of disposing transparent resin 360 in liquid form on a surface of each of first light-emitting element 10 and second light-emitting element 20 as illustrated in FIG. 8B, and a process of causing light-transmissive sheet 70 to be in contact with transparent resin 360 as illustrated in FIG. 8C. The surface of each of first light-emitting element 10 and second light-emitting element 20 faces light-transmissive sheet 70. According to the present embodiment, since it is not necessary to turn over base 50 unlike the method of manufacturing light source 201 according to Embodiment 3, it is possible to simplify the manufacturing process. According to the present embodiment, first light-emitting element 10 and second light-emitting element 20 are caused to sink into transparent resin 360 as illustrated in FIG. 8C. In other words, light-transmissive sheet 70 is pressed to first light-emitting element 10 and second light-emitting element 20 to cause a portion of each of first light-emitting element 10 and second light-emitting element 20 on a side close to light-transmissive sheet 70 to be disposed inside transparent resin 360. In this manner, transparent resin 360 is attached to a portion of a side surface of each of first light-emitting element 10 and second light-emitting element 20.

In addition, the forming process further includes a process of curing transparent resin 360 to be reflector 362, in a state in which light-transmissive sheet 70 is in contact with transparent resin 360, as illustrated in FIG. 8D. As illustrated in FIG. 8D, reflector 362 includes fillet section 363 and fillet section 364 formed in proximity to a side surface of first light-emitting element 10 and a side surface of second light-emitting element 20, respectively, when transparent resin 360 is cured in the state in which light-transmissive sheet 70 is in contact with transparent resin 360 in liquid form. Fillet section 363 and fillet section 364 are respectively formed as a result of transparent resin 360 being cured while shrinking, in a state in which a lower end portion of transparent resin 360 in a vertical direction (direction of axis Z) is attached to the side surface of each of first light-emitting element 10 and second light-emitting element 20.

With the manufacturing method including the first process, the second process, and the third process described above, it is possible to manufacture light source 301 according to the present embodiment.

[4-3. Conclusion]

As described above, in the method of manufacturing light source 301 according to the present embodiment, the forming process includes the process of disposing transparent resin 360 in liquid form on the surface of each of first light-emitting element 10 and second light-emitting element 20, and the process of causing light-transmissive sheet 70 to be in contact with transparent resin 360. The surface of each of first light-emitting element 10 and second light-emitting element 20 faces light-transmissive sheet 70. In addition, the forming process further includes the process of curing transparent resin 360 to form reflector 362, in the state in which light-transmissive sheet 70 is in contact with transparent resin 360.

In this manner, it is possible to easily dispose reflector 362 even when the gap between first light-emitting element 10 and second light-emitting element 20 is narrow. Furthermore, with the method of manufacturing light source 301 according to the present embodiment, since it is not necessary to turn over base 50 in the forming process, it is possible to simplify the process.

### Embodiment 5

The following describes a light source according to Embodiment 5. With the light source according to the present embodiment, it is possible to further enhance reflection efficiency of a reflector compared to light source 201 according to Embodiment 3. In addition, the light source according to the present embodiment includes a lens, and thus it is possible to adjust light distribution characteristics. The following describes the light source according to the present embodiment focusing on the difference from light source 201 according to Embodiment 3.

[5-1. Configuration]

The following describes a configuration of the light source according to the present embodiment, with reference to the drawings.

FIG. 9 is a cross-sectional diagram illustrating a configuration of light source 401 according to the present embodiment.

As illustrated in FIG. 9, light source 401 according to the present embodiment, as with light source 201 according to Embodiment 3, includes: base 50; first light-emitting element 10; second light-emitting element 20; reflector 62; and light-transmissive sheet 70. Light source 401 further includes, as reflector 52, a white component disposed between base 50 and reflector 62 (transparent component). Light source 401 further includes air layer 56 between reflector 62 and reflector 52. In addition, light source 401 further includes lens 80 disposed on light-transmissive sheet 70.

Reflector 52 has a shape of a substantially triangular pole as illustrated in FIG. 9, and has reflective surface 53 facing first light-emitting element 10 and reflective surface 54 facing second light-emitting element 20. It is possible to reflect off reflective surface 53 a component that travels toward second light-emitting element 20 among components of the first emission light, and reflect off reflective surface 54 a component that travels toward first light-emitting element 10 among components of the second emission light. In addition, according to the present embodiment, reflector 52 is disposed on the front surface of base 50. Accordingly, when reflector 52 is disposed on a line formed on base 50, reflector 52 also functions as a protection component for the line.

The material of reflector 52 is not specifically limited as long as the material is a white component capable of reflecting the first emission light and the second emission light. As the material of reflector 52, for example, a PBT, a white silicone resin, etc. can be employed.

Air layer 56 is a void between reflector 62 which is a transparent component and reflector 52 which is a white component. Light source 401 is capable of totally reflecting the first emission light and the second emission off an interfacial surface between reflector 62 and air layer 56, by including air layer 56 which has a refractive index lower than a refractive index of reflector 62.

With reflector 52 included in light source 401, it is possible to reflect, among components of the first emission light, a component that travels toward second light-emitting element 20 and is not totally reflected by reflector 62, as illustrated by dashed-dotted lines in FIG. 9. In the same manner as above, with reflector 52, it is possible to reflect, among components of the second emission light, a component that travels toward first light-emitting element 10 and is not totally reflected by reflector 62. Thus, with light source 401 according to the present embodiment, it is possible to further reduce components that enter second light-emitting element 20 among the components of the first emission light, and components that enter first light-emitting element 10 among the components of the second emission light.

Lens 80 is an optical element that controls light distribution of each of the first emission light and the second emission light. According to the present embodiment, lens 80 is disposed at a position corresponding to first light-emitting element 10 and a position corresponding to second light-emitting element 20, and controls the light distribution of the first emission light and the second emission light. The material of lens 80 is not specifically limited. As the material of lens 80, for example, PC, glass, etc. can be employed.

[5-2. A Manufacturing Method]

Next, a method of manufacturing light source 401 according to the present embodiment shall be described.

The method of manufacturing light source 401 further includes, in the method of manufacturing light source 201 according to Embodiment 3, a process of disposing, as reflector 52, a white component between base 50 and reflector 62.

Reflector 52 is disposed on base 50 prior to the forming process of forming, as reflector 62, a transparent component which totally reflects, among components of the first emission light, a component that travels toward second light-emitting element 20.

As described above, light source 401 according to the present embodiment can be manufactured.

[5-3. Conclusion]

As described above, light source 401 according to the present embodiment further includes lens 80 disposed on light-transmissive sheet 70.

In this manner, it is possible to control light distribution of the first emission light and second emission light.

In addition, reflector 52 further includes a white component disposed between base 50 and reflector 62 (transparent component).

In this manner, with reflector 52, it is possible to reflect, among components of the first emission light, a component that travels toward second light-emitting element 20 and is not totally reflected by reflector 62. In the same manner as above, with reflector 52, it is possible to reflect, among components of the second emission light, a component that travels toward first light-emitting element 10 and is not totally reflected by reflector 62. Thus, with light source 401 according to the present embodiment, it is possible to further reduce components that enter second light-emitting element 20 among the components of the first emission light, and components that enter first light-emitting element 10 among the components of the second emission light.

In addition, light source 401 may further include air layer 56 between reflector 62 (transparent component) and reflector 52 (white component).

In this manner, it is possible to totally reflect the first emission light and the second emission off an interfacial surface between reflector 62 and air layer 56.

In addition, in the method of manufacturing light source 401 according to the present embodiment, the third process further includes a process of disposing, as reflector, reflector 52 (white component) between base 50 and reflector 62 (transparent component).

Reflector 52 disposed in the above-described manner is capable of reflecting, among components of the first emission light, a component that travels toward second light-emitting element 20 and is not totally reflected by reflector 62.

### Embodiment 6

Next, a luminaire according to Embodiment 6 shall be described with reference to the drawings.

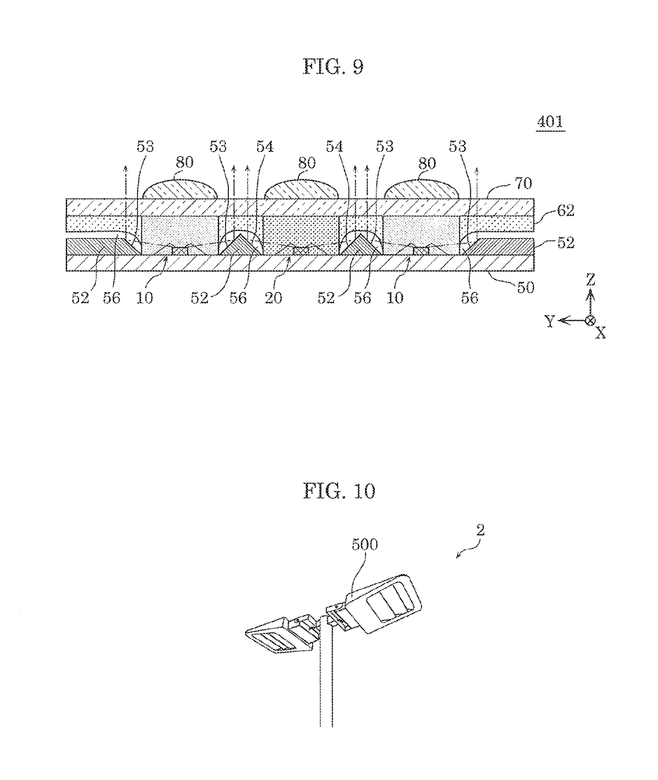

FIG. 10 is an external view of luminaire 2 according to the present embodiment.

Luminaire 2 includes any one of the light sources according to Embodiments 1 to 5. According to the present embodiment, luminaire 2 is a luminaire for street lighting, and includes lighting body 500 to which a light source is attached.

Luminaire 2 described above includes any one of the light sources according to Embodiments 1 to 5, and thus it is possible to obtain advantageous effects same as or similar to the advantageous effects of each of the above-described embodiments.

### Modification Example, Etc.

Although aspects of the light source, etc. according to present disclosure are described based on the embodiments, the present disclosure is not limited to the above-described embodiments.

For example, in each of the above-described embodiments, an example in which first light-emitting element 10 and second light-emitting element 20 are arranged in a linear manner is described. However, the arrangement configuration of first light-emitting element 10 and second light-emitting element 20 is not limited to this example. For example, first light-emitting element 10 and second light-emitting element 20 may each be disposed at a position corresponding to each of vertexes of a triangle.

In addition, in each of the above-described embodiments, an example in which a light-emitting element of the COB type is used as first light-emitting element 10 and second light-emitting element 20 is described. However, first light-emitting element 10 and second light-emitting element 20 is not limited to the light-emitting element of the COB type. For example, first light-emitting element 10 and second light-emitting element 20 may be a light-emitting element of a surface mount device (SMD) type.

In addition, in each of the above-described embodiments, an example in which a light-emitting diode chip is used in first light-emitting element 10 and second light-emitting element 20 is described. However, an organic electro luminescence (EL) chip or the like may be used instead.

In addition, in each of the above-described embodiments, a mounting board which has a flat-plate shape is used as base 50. However, base 50 is not limited to the mounting board which has the flat-plate shape. For example, base 50 may have a block shape.

Moreover, embodiments obtained through various modifications to the respective embodiments which may be conceived by a person skilled in the art as well as embodiments realized by arbitrarily combining the structural components and functions of the respective exemplary embodiments without materially departing from the spirit of the present disclosure are included in the present disclosure.

For example, reflector 52 according to Embodiment 5 may be used in light source 301 according to Embodiment 4.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A light source, comprising:
a base;
a first light-emitting element which is disposed on the base and emits first emission light having a first spectrum;
a second light-emitting element which is disposed on the base adjacent to the first light-emitting element, and emits second emission light having a second spectrum different from the first spectrum; and
a reflector which is disposed between the first light-emitting element and the second light-emitting element, and reflects, among components of the first emission light, a component of the first emission light that travels toward the second light-emitting element.

2. The light source according to claim 1,
wherein the reflector reflects, among components of the second emission light, a component of the second emission light that travels toward the first light-emitting element.

3. The light source according to claim 1,
wherein the first light-emitting element includes a first light-emitting diode chip disposed on the base, and a first sealing component that covers the first light-emitting diode chip, and
the second light-emitting element includes a second light-emitting diode chip disposed on the base, and a second sealing component that covers the second light-emitting diode chip.

4. The light source according to claim 1,
wherein the reflector is white in color and has a dam-like shape, and is disposed in a standing manner on the base.

5. The light source according to claim 1,
wherein the reflector is a diffuser.

6. The light source according to claim 5,
wherein the diffuser includes a light-transmissive resin and a diffuser particle contained in the light-transmissive resin.

7. The light source according to claim 1, further comprising:
a light-transmissive sheet which is disposed opposite to the base and covers the first light-emitting element and the second light-emitting element,
wherein the reflector includes a transparent component, the transparent component being disposed on the light-transmissive sheet and reflecting the component of the first emission light that travels toward the second light-emitting element.

8. The light source according to claim 7, further comprising:
a lens disposed on the light-transmissive sheet.

9. The light source according to claim 7,
wherein the reflector further includes a white component, the white component being disposed between the base and the transparent component.

10. The light source according to claim 9, further comprising:
an air layer between the transparent component and the white component.

11. The light source according to claim 1,
wherein a distance between the first light-emitting element and the second light-emitting element is at most equal to five times a thickness of one of the first light-emitting element and the second light-emitting element.

12. The light source according to claim 1,
wherein the reflector has a shape of a triangular pole, and
the reflector reflects the component of the first emission light toward a main emission direction of the first light-emitting element.

13. A luminaire, comprising:
the light source according to claim 1.

14. A method of manufacturing a light source including: a base; a first light-emitting element which emits first emission light having a first spectrum; and a second light-emitting element which emits second emission light having a second spectrum different from the first spectrum, the method comprising:
disposing the first light-emitting element on the base;
disposing the second light-emitting element on the base adjacent to the first light-emitting element; and
disposing a reflector between the first light-emitting element and the second light-emitting element, the reflector reflecting, among components of the first emission light, a component that travels toward the second light-emitting element.

15. The method of manufacturing the light source according to claim 14,
wherein the disposing of the first light-emitting element includes: mounting a first light-emitting diode chip on the base; and covering the first light-emitting diode chip with a first sealing component, and
the disposing of the second light-emitting element includes: mounting a second light-emitting diode chip on the base; and covering the second light-emitting diode chip with a second sealing component.

16. The method of manufacturing the light source according to claim 14,
wherein the disposing of the reflector is performed after the disposing of the first light-emitting element and the disposing of the second light-emitting element.

17. The method of manufacturing the light source according to claim 14,
wherein the disposing of the reflector includes forming, as the reflector, a transparent component on a light-transmissive sheet that covers the first light-emitting element and the second light-emitting element, the transparent component reflecting the component of the first emission light that travels toward the second light-emitting element.

18. The method of manufacturing the light source according to claim 17,
wherein the forming includes: disposing a transparent resin in liquid form on a side of the light-transmissive sheet; causing the first light-emitting element and the second light-emitting element which are disposed on the base to be in contact with the transparent resin; and curing the transparent resin to form the reflector, in a state in which the first light-emitting element and the second light-emitting element are in contact with the transparent resin.

19. The method of manufacturing the light source according to claim 17,
wherein the forming includes: disposing a transparent resin in liquid form on surfaces of the first light-emitting element and the second light-emitting element; causing the light-transmissive sheet to be in contact with the transparent resin; and curing the transparent resin to form the reflector, in a state in which the light-transmissive sheet is in contact with the transparent resin, the surfaces facing the light-transmissive sheet.

20. The method of manufacturing the light source according to claim 17,
wherein the disposing of the reflector further includes disposing, as the reflector, a white component between the base and the transparent component.
